(19) United States
(12) Patent Application Publication
(10) Pub. No.: US 2005/0027672 A1
(43) Pub. Date: Feb. 3, 2005

(54) Personal Internet identity verification system

(76) Inventors: Jeffrey A. Arndt, Reno, NV (US); Daniel A. Seidler, Hudson, WI (US)

Correspondence Address: Felix J. Sahlin, 1480 Mississippi River Boulevard S., St. Paul, MN, 55116-1853, US

(21) Appl. No.: 10/632,492

(22) Filed: Jul. 31, 2003

(51) Int. Cl. G06F 7/00

(52) U.S. Cl. 707/1

(57) ABSTRACT

An individual identification verification system is provided for persons to verify their identity to third persons who they meet in various internet sites in a safe, confidential manner and wherein the extent and manner of information are controllable by the person whose identity and background is being verified. The system provides the following improvements: control of the extent of disclosure by the individual being investigated, information is given on a secure site, unlimited access and referrals, updateability, and interoperability with other media including print and telephone dating services.

### CROSS REFERENCE TO RELATED APPLICATIONS

Not Applicable

### STATEMENT CONCERNING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of Invention

The present invention generally relates to means for third persons to verify the identity of persons who they meet in chat rooms, personals sites, dating services and other similar sites on the internet

2. Description of Prior Art

There is a public perception that the Internet is a dangerous place to meet people. There are numerous stories in the media about meetings which result in at minimum, embarrassment and at worst, serious crimes. Yet, tens of thousands of persons meet every day on line on the Internet and thousands eventually meet in person. Some Internet “personals” sites have more than two million members.

When an individual is on line he or she does not know if the person or persons on the other end are telling the truth about themselves. In fact, they may not be sure of the sex, age, location or marital status of that individual. At the other end of the conversation the issues are often the same. Each individual knows the truth about themselves but is either unable or because of security or other concerns, unwilling to prove who and what they are.

At present background check or verification services require that another person get private information about the individual being investigated and pass it along to the background verification company. The information gathered or discovered by the company is then sent to the person ordering it. There are several problems with this method of obtaining information about another person. First, there are very sound, prudent reasons why people should not and do not give out information relating to their date of birth coupled with their address, full name and most importantly, their social security number. Second, criminal background checks are often incomplete because there is no nationally centralized archive of criminal convictions. Third, the release of information is limited to a single use by a single individual or entity. Fourth is the lack of control by the individual being vetted. Finally, there is the cost of investigating a number of individuals.

At the time of filing there are approximately fifty-five background services listed on the World Wide Web. Four are specifically aimed at personals. None allow the person being investigated to have any control over the content of the information released. All other background check services require the individual seeking background information to know or obtain the social security number, address, date of birth and/or other information for another person. This is all very private information, placed in the hands of third parties without any control by the person being investigated. A parallel example is the age/id checks on adult access web sites which rely on a credit card number and an affirmation of suitable age by the person seeking access.

### SUMMARY OF THE INVENTION

The present invention provides a system for verifying an individual's identity and background on the Internet in a safe, confidential manner and wherein the extent and manner of information are controllable by the person whose identity and background is being verified.

The system provides the following improvements: control of the extent of disclosure by the individual being investigated, information is given on a secure site, unlimited access and referrals, updateability, and interoperability with other media including print and telephone dating services.

### BRIEF DESCRIPTION OF THE DRAWINGS

FIG. 1 is a flowchart depicting the flow and presentation of information in the management of the web site using the data collection and processing system according to the present invention.

FIG. 2 is a flowchart depicting the process of gathering, verifying and presenting personal identification and background information which is gathered and processed according to the present invention.

FIG. 3 is a flowchart depicting the background information verification process and the linkage the unique Member ID of the applicant with their verified background data.

FIG. 4

FIG. 5 presents the creation of a Guest Invitation Profile.

FIG. 6 diagrams the process for sending invitation to a Guest to view the Member's information.

### DESCRIPTION OF THE PREFERRED EMBODIMENT OF THE INVENTION

The preferred embodiment of the invention consists of a web site incorporates a public main home page and a private “back room”. The public portion of the site uses a secure server, a computer system designed to store and disseminate data utilizing a disk array and/or firewall system to contain, control and direct all data and drive access. Here, the secure server encrypts data provided by a user to protect the data from hacking or theft.

The home page may contain links to Ad Copy, an Interactive Example of the Member profile, F.A.Q (Frequently Asked Questions), Privacy Disclosure Disclaimers, Contact Us, Terms of Service, Member's Log In and Sign Up Now and optionally, links to affiliated sites.

The Member does not have direct dynamic access to their specific data files, that is a direct connection through which the applicant has the ability to modify or edit the source data file.

Instead, the user modifies a separate data table linked solely to their data table by data query for output and display purposes by a unique Member Identifier.

An individual applicant becomes a user or new member by accessing the web site, clicking on the “join” tab and proceeding through a series of drop down boxes, responding to question and data fields to provide the information required to perform the background check. The information includes for example, Full name, sign in ID Name, Creation and Confirmation of a user changeable password, Citizenship, Address, Residence (Previous Addresses), Birth date, Social Security Number, Drivers License Number, Credit Card information including type, billing name, billing address, card number, expiration date. The data is used to create a one time non accessible Member Data Table. Disclaimers and terms of service are incorporated into the pages. Terms of Service include privacy guidelines, policies and procedures for disputing information and appealing background findings, security and turn around time. Links to affiliated sites are also displayable.

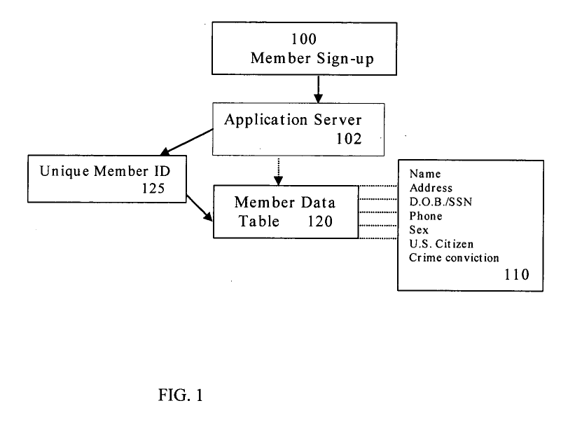

The Member sign up process is outlined in FIG. 1. During Member sign-up (100), data is written to a data table through the application server (102). The Member is assigned a unique Member Identification Number (125) which serves to match the Member with their respective Member Data Table (120). Data (110) in the Member Data Table includes for example: Full name, sign in ID Name, Creation and Confirmation of a user changeable password, Citizenship, Address, Residence (Previous Addresses), Birth date, Social Security Number, Drivers License Number, Credit Card information including type, billing name, billing address, card number, expiration date.

Credit reports, criminal record checks, social security number and personal references are obtained from third party data bases and vendors. The results obtained are manually entered into a Member Results Table. The Member Data and Results tables are only linked via data query and joined by the Member identification code. Options for confirmation of identity via mailed, faxed or emailed photo facsimile of the driver's license, passport or other government identification document or via a check of the new Member's driver's license may also be used.

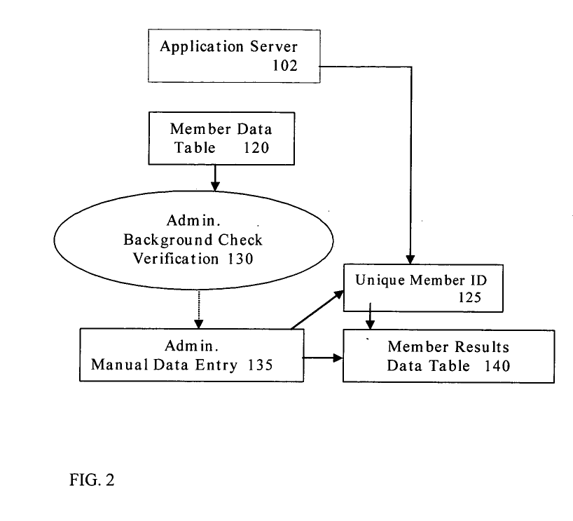

FIG. 2 diagrams the process of back room verification of Member background information. The results Administrative Background Check Verification (130) using third-party sources are manually entered (135) to a Member Results Data Table (140). The results of the background information verification (130) and the Member Results Data Table (140) are only linked by data query and joined by a unique Member ID (125).

Pertinent data is sorted into qualifier categories for Member acknowledgment. Credit data is sorted into fields subsisting of “Good, Fair, Poor and Challenged” as defined by the financial services credit scores obtained. Felony and Misdemeanor data found is reflected by a “positive hit”, a notation indicating in the reflective qualifier category that the background check found some criminal or public record. The positive hit does not does not address the specific details of said data.

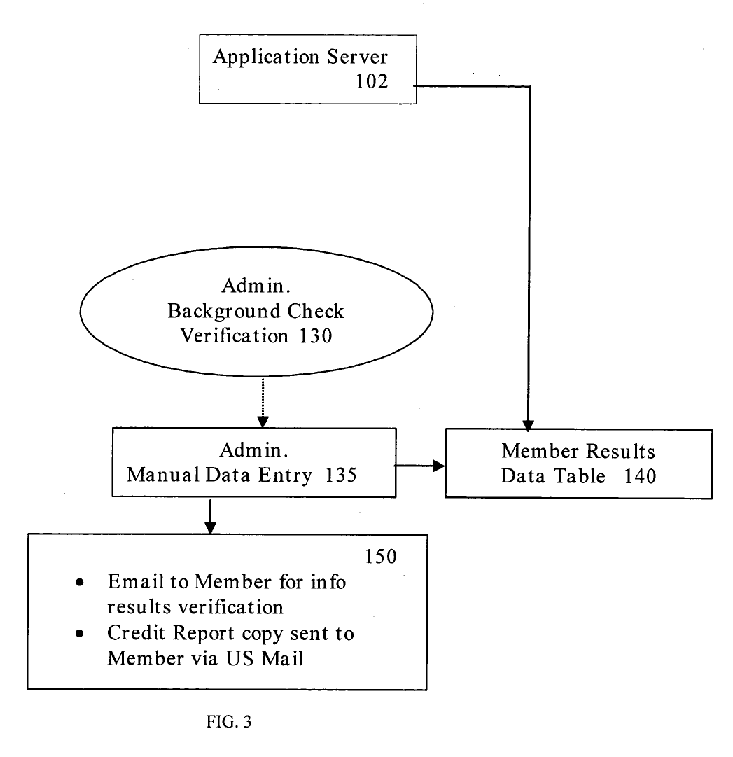

FIG. 3 diagrams initiation the verification of data by a Member. Administrative Background Check Verification (130) using third-party sources are manually entered (135) to a Member Results Data Table (140).). Upon completion an Email (150) is sent to the Member, requesting the Member to confirm the accuracy of results found (or challenge discrepancies). A copy of the Member's credit report is forwarded via U.S. mail.

Members may review their profiles created from the Member Results Table by signing in and going to a page with a list of options created for them using information collected from the background check. Options which are activated by checking include: Full, name, Address, Social Security verification, Credit Report, Criminal background checks, Driving record, employment, marital status. Address and employment have the further option of being verified but not revealed. Social security numbers are be verified but never revealed. Other security measures including non linkage of backroom storage systems with the web site it self, make attempts to hack the records storage area via the web site much more difficult. Members have the opportunity to dispute findings according the policies published on the web site.

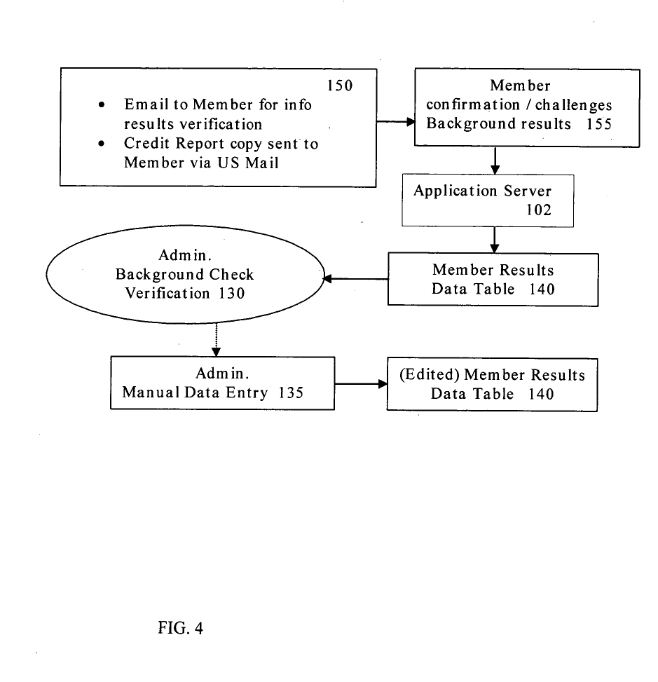

FIG. 4 tracks the verification process by the Member. Upon receipt of the email (150) containing the Membership Results Data Table, Member confirms or challenges the background results as verified (155) by via email. If the Member challenge is allowed, the corrected data is manually entered (135) in the (Edited) Member Results Data Table (140).

All fields have an option for attachment of complete definitions. The definitions disclose how the information was obtained, limitations of disclosure (for example social security number), definitions of term and contain a link to disclaimer and policies.

Control over disclosure rests with the Member. The information is given on a secure site, and a stranger is not passing along private information. The system provides selective disclosure of what information the Member chooses to reveal. All disclosures are defined to both Members and guests.

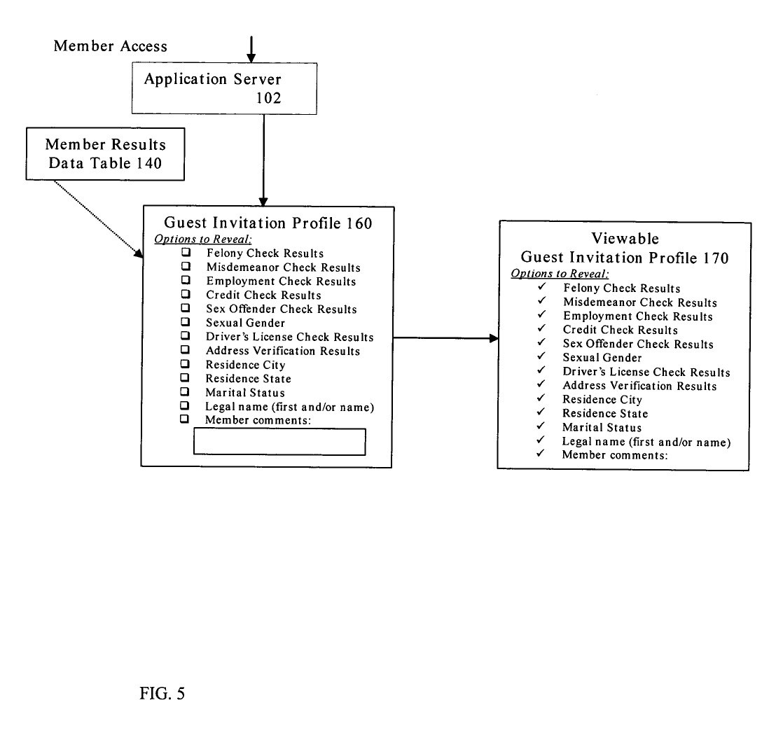

FIG. 5 presents the creation of a Guest Invitation Profile. A Member creates a Guest Invitation Profile (160) by accessing the Member's Member Results Table (140) as finalized via the Application Server (102). The Member chooses which options to reveal on the Guest Invitation Profile (160) by clicking the box next to the Options to Reveal. The Member may also add comments to explain anything they have chosen or declined to reveal on the Guest Invitation. The resulting Viewable Guest Invitation Profile (170) is stored on the Application Server (102)

The process represented by FIGS. 4 and 5 can be repeated and modified with varying options with revealed/not revealed information as many times as desired by the member.

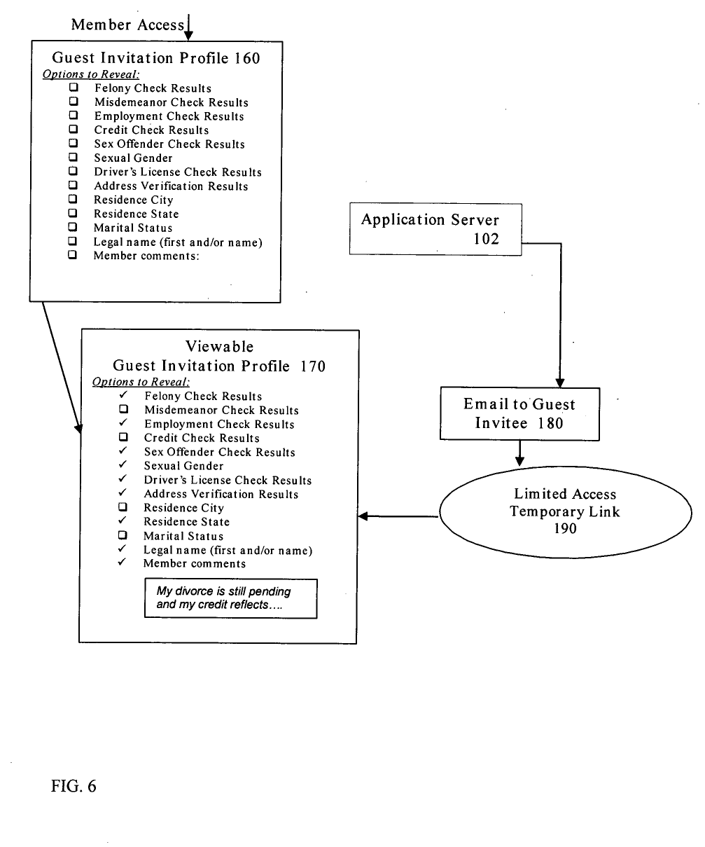

FIG. 6 outlines the process for sending invitation to a Guest to view the Member's information. The Member after choosing which items of information to reveal to a recipient, enters the recipient's email address and sends the Invitation Email (180) via the Application Server (102) to the Guest. The Guest receives the email (180), which contains an invitation to go to the enclosed Limited Access Temporary Link (190) and view the customized page listing the results selected by the Member (170).

This link is restricted to a specified number of views by the PersonaCheck system and will expire in a predetermined time and fashion. Only the information that the Member has chosen to reveal is displayed in the Guest Invitation Profile. Guests are given the option to review the disclaimer and privacy policies, informed how many days they will have access to the member's site, given an advertisement for the service and invited to join. Links to affiliates and a Member search with no date to prevent unauthorized use of logo on nonmember's pictures and personals are also included. The system also allows the Member to authenticate a photo as presented by the Member by application of the PersonaCheck service mark to the photograph by the company

The exercise of creating a Personal Profile can be repeated as often as desired for as many invitees as desired by a member during the life of the membership.

The verification process may also have use in the areas of employment and housing applications and other means by which a third party identification system can be useful.

1. a method for verification of an individual's identity comprising:
a. entering identifying background information by the applicant;
b. assigning a unique identifier to the applicant's personal profile;
c. verifying the validity of applicant's the background information;
d. sorting and categorizing the verified data for review by the applicant;
e. matching the applicant's verified personal data with the applicant,
f. review of the verified data by the applicant for accuracy;
g. creating a personal profile by the applicant using the verified data;
h. posting applicant's personal profile in a data base;
i. issuance of an invitation by applicant to a third party to view applicant's personal profile.

2. A data processing system for verification of an individual's identification comprising:
a. a computer for processing data;
b. storage means for storing data on a storage system;
c. first means for initializing the storage medium;
d. second means for processing applicant's identification data;
e. third means for independently verifying the existence and accuracy of the applicant's identification data;
f. fourth means for sorting identification data into categories for applicant review;
g. fifth means for applicant to verify the accuracy the independent verification of applicant's identification data;
h. sixth means for applicant to challenge all or part of results of independent verification of identification data;
i. seventh means for applicant to create a personal profile from applicant's verified identification data;
j. eighth means for assignment of a unique identifier for the applicant's profile.
k. ninth means for applicant to issue invitation(s) to third parties to view applicant's profile;
l. means for third party to view applicant's personal profile.

3. A method for verification of an individual's identity as claimed in claim 1 wherein the background information comprises the applicant's: name, preferred and legal.

4. A method for verification of an individual's identity as claimed in claim 1 wherein the background information comprises the applicant's date of birth.

5. A method for verification of an individual's identity as claimed in claim 1 wherein the background information comprises the applicant's sex.

6. A method for verification of an individual's identity as claimed in claim 1 wherein the background information comprises the applicant's social security number.

7. A method for verification of an individual's identity as claimed in claim 1 wherein the background information comprises the applicant's citizenship.

8. A method for verification of an individual's identity as claimed in claim 1 wherein the background information comprises the applicant's acknowledgement of any criminal convictions.

9. A method for verification of an individual's identity as claimed in claim 1 wherein applicant's background information is verified by one or more third party sources.

10. A method for verification of an individual's identity as claimed in claim 1 wherein pertinent credit data is sorted into fields of “Good”, “Fair” “Poor” and “Challenged” as defined by the financial credit scores obtained.

11. A method for verification of an individual's identity as claimed in claim 1 wherein Felony and Misdemeanor data found during verification is reflected by a “positive hit” without regard to the specific details of the data.

12. A method for verification of an individual's identity as claimed in claim 1 wherein the applicant's verified identification data may be accessed on a restricted basis for the applicant to verify or challenge its accuracy.

13. A method for verification of an individual's identity as claimed in claim 1 wherein the applicant's personal profile can be modified to display all or some of the following data:
felony convictions, misdemeanor convictions, employment verification, credit score, sexual offender classification, gender, drivers license possession, address, city of residence, state of residence, marital status, legal name, comments.

14. A method for verification of an individual's identity as claimed in claim 1 wherein the applicant's does not have direct dynamic access to their personal profile but can only modify a separate data table joined to their data table by data query for output and display purposes by a unique member identifier.

15. A method for verification of an individual's identity as claimed in claim 1 wherein the applicant's invitation to view their respective personal profile is not sent from the applicant directly but from a third party automated email processing system.

16. A method for verification of an individual's identity as claimed in claim 1 wherein the applicant's invitation to view their respective personal profile is viewable only through an email access link through a secure server.

17. A data processing system as claimed in claim 2, wherein the computer processing means comprises a. means for imputing and storing the applicant's name, preferred and legal;

18. A data processing system as claimed in claim 2, wherein the computer processing means comprises a. means for imputing and storing the applicant's address including city, state and zip code.

19 A data processing system as claimed in claim 2, wherein the computer processing means comprises a. means for imputing and storing the applicant's telephone number(s).

20. A data processing system as claimed in claim 2, wherein the computer processing means comprises a. means for imputing and storing the applicant's date of birth,

21. A data processing system as claimed in claim 2, wherein the computer processing means comprises a means for imputing and storing the applicant's sex,

22. A data processing system as claimed in claim 2, wherein the computer processing means comprises a means for imputing and storing the applicant's social security number,

23. A data processing system as claimed in claim 2, wherein the computer processing means comprises a means for imputing and storing the applicant's citizenship,

24. A data processing system as claimed in claim 2, wherein the computer processing means comprises a means for imputing and storing the applicant's acknowledgement of any criminal convictions.

25. A data processing system as claimed in claim 2, wherein the third means comprises an independent entity to verify the applicant's felony convictions, misdemeanor convictions, employment verification, credit score, sexual offender classification, gender, drivers license possession, address, city of residence, state of residence, marital status and legal name.

26. A data processing system as claimed in claim 2, wherein the fourth means comprises a data base for sorting data regarding applicant's credit data, any criminal convictions, employment, gender, drivers license possession, verification of residence address and marital status,

27. A data processing system as claimed in claim 2, wherein the fifth means comprises a secure data link with access restricted to applicants allowing applicant to verify or challenge the accuracy of their identity verification data.

28. A data processing system as claimed in claim 2, wherein the sixth means comprises a template for applicants to create a personal profile for viewing by a third party, said template allowing the applicant to include or exclude identity verification data from the personal profile.

29. A data processing system as claimed in claim 2, wherein the seventh means comprises a template for applicants to create a personal profile for viewing by a third party, said template allowing the applicant to include or exclude data concerning the applicant's credit data, any criminal convictions, employment, gender, drivers license possession, verification of residence address, marital status, or add personal comments.

30. A data processing system as claimed in claim 2, wherein the eighth means comprises an electronically generated sequence of numbers and letters.

31. A data processing system as claimed in claim 2, wherein the ninth means comprises an automated email system operated on a secure server without direct access for link between the applicant and the third party/invitee.

32. A data processing system as claimed in claim 28, wherein the seventh means further comprises a digitized photograph submitted by the applicant.

33. A data processing system as claimed in claim 29, wherein the eighth means further comprises an automated email system operated on a secure server without direct access between the applicant and the third party/invitee which limits the time for which the applicant's profile may be viewed.

34. A data processing system as claimed in claim 30, wherein the seventh means further comprises a PersonaCheck tm service mark applied to the digitized photograph of the applicant as presented by the applicant.

35. A data processing system as claimed in claim 17, wherein the computer processing means further comprises a means for imputing and processing the applicant's credit card information for payment for use of the system.

36. A method for verification of an individual's identity as stated in claim 1, further comprising two non linked or connected data bases, one for input of identity verification data by applicant and one for creation and display of applicant's personal profile.

37. A data processing system for verification of an individual's identity as stated in claim 8 further comprising the notation “declined” as the response to any item which applicant chooses to exclude from their personal profile.

38. A data processing system for verification of an individual's identity as stated in claim 15 wherein the applicant's verification or challenge to applicant's verified identification data is conducted via a secure internet server link.

39. A method for verification of an individual's identity as stated in claim 1, further comprising a single access to applicant's personal profile by a third party.

40. A method for verification of an individual's identity as stated in claim 4 wherein applicant's identification information self report is verified using a credit reporting service.

41. A method for verification of an individual's identity as stated in claim 4 wherein applicant's criminal history if any is verified using a criminal conviction database service.

42. A data processing system for verification of an individual's identity as stated in claim 12 wherein applicant's credit card is charged based on a membership level.

43. A computer-readable medium encoded with instructions that cause a data processing system to perform a method comprising the steps of:
a. entering identifying background information provided by the applicant;
b. verifying the validity of applicant's the background information;
c. sorting and categorizing the verified data for review by the applicant;
d. transmitting the verified data to the applicant for accuracy;
e. creation of a personal profile by the applicant using the verified data;
f. assigning a unique identifier to the applicant's personal profile;
g. posting applicant's personal profile in a data base;
h. at applicants request, issuing invitation to third parties to view applicant's personal profile.
